(19) United States
(12) Patent Application Publication
(10) Pub. No.: US 2015/0174693 A1
(43) Pub. Date: Jun. 25, 2015

(54) Welder With Active Linear DC Filtering Circuit

(71) Applicants: Aaron Astle, Payson, UT (US); Aaron J. Ford, Provo, UT (US); Luke B. Peacock, Santaquin, UT (US); Larin A. Dodgen, Payson, UT (US)

(72) Inventors: Aaron Astle, Payson, UT (US); Aaron J. Ford, Provo, UT (US); Luke B. Peacock, Santaquin, UT (US); Larin A. Dodgen, Payson, UT (US)

(21) Appl. No.: 14/640,495

(22) Filed: Mar. 6, 2015

Related U.S. Application Data
(63) Continuation-in-part of application No. 14/262,743, filed on Apr. 26, 2014.
Application No. 14/262,743 is a continuation-in-part of application No. 14/084,575, filed on Nov. 19, 2013.

(51) Int. Cl. B23K 11/24; B23K 10/00; B23K 11/26

(52) U.S. Cl. CPC B23K 11/243; B23K 11/26; B23K 10/006

(57) ABSTRACT

A linear DC welder for enhanced welding capabilities comprises one or more active filtering circuits. The active filtering circuit(s) are capable of producing a variety of user-configurable and user-controllable custom waveforms for use in various welding applications. The custom waveforms may be created and combined via the use of overlay waveforms and, in at least some preferred embodiments of the present invention, include agitation waveforms. The overall operation of the welder, including the power supply and the active filtering circuit can be controlled via an integrated feedback cycle that provides for the monitoring and adjustment of multiple weld process parameters including volts, amps, power, resistance, and displacement. Additionally, a low current ignition (“LCI”) circuit may also be included to provide for additional welding options.

### RELATED APPLICATIONS

This patent application is a continuation-in-part of U.S. patent application Ser. No. 14/262,743, which application was filed on Apr. 26, 2014 and which application is currently pending and which application is incorporated herein by reference.

This patent application is a continuation-in-part of U.S. patent application Ser. No. 14/084,575, which application was filed on Nov. 19, 2013 and which application is currently pending and which application is incorporated herein by reference.

This patent application is also a continuation-in-part of U.S. patent application Ser. No. 13/674,022, which application was filed on Nov. 12, 2012 and which application is now pending and which application is incorporated herein by reference.

### BACKGROUND OF THE INVENTION

1. Technical Field

The present invention relates to the field of welding and more specifically relates to controlling the output from a power supply used in various welding applications.

2. Background Art

There are a wide variety of welding devices manufactured for use in various welding applications. Each type of welding device will provide different welding capabilities, depending on the technology used to create and control the weld energy generated by the welder. Welder technologies may be broadly characterized by the type of power supply and related controls that are available for use in the welding process.

In Linear DC power supplies, a bank of capacitors is charged up and the welding energy is released through a bank of transistors that are coupled to the capacitor bank and an uncharged smaller filter capacitor or bank of capacitors. Linear DC power supplies are generally characterized by their ability to deliver a very stable output with a relatively fast rise time. Most DC power supplies can be programmed to maintain constant current, constant voltage, or constant power. Because DC power supplies offer excellent low energy control, DC power supplies are often used for applications such as welding fine wires and thin foils.

High frequency inverter technology utilizes pulse width modulation circuitry to control the weld energy. Typically, a 3-phase input current is full wave rectified to DC, which is then switched to produce an AC current at the primary terminal of a welding transformer. The resulting secondary current, when rectified, is in the form of a DC power source with an imposed, low-level AC ripple. Like Linear DC welders, High Frequency Inverters can be programmed for constant current, voltage, or power operation. Since High Frequency Inverters have relatively rapid repetition rates, they are frequently used for automated applications that can be controlled by programmable electronic circuits.

Capacitor Discharge (CD) power supplies store energy in a capacitor bank prior to the weld. The energy is discharged through a pulse transformer to the weld head. The resulting high peak current and relatively fast rise time is useful for welding very conductive parts. The level of charge on the capacitor bank is usually programmed in terms of watt-seconds, Joules, or % energy the welder is capable of producing. Time control may be achieved by changing the transformer tap settings, which changes the pulse duration, or pulse width. Unfortunately, since a CD power supply is open loop with no feedback, changes in the secondary circuit, such as loose cables or corroded connections can result in inconsistent energy delivery to the parts.

Direct Energy (AC) power supplies take energy directly from the power line as the weld is being made. Coarse current control is achieved by changing the tap settings on the welding transformer, which changes the voltage of the output. Fine adjustment of weld current may be achieved by controlling the amount, in percent, of the AC power that is applied to the primary terminal of the welding transformer. Line voltage fluctuations can affect the weld current delivered by typical AC power supplies. For this reason, the input line must be well regulated to achieve consistent weld current. AC power supplies are general purpose welders with high energy output and are generally not suitable for critical, fine welding applications. The longer welding times offered by an AC power supply are also useful for resistance brazing applications.

Typical linear DC micro welders provide excellent results for common applications such as controlled micro-miniature resistance welding and thermocompression bonding processes.

When using commonly known CD welding systems in certain welding processes (e.g. thermocompression bonding) it is quite common to experience a large number of failures caused by weak bonds. Conversely, using a DC welding system for the same application can provide good joint strength but may be cost prohibitive due to the relatively high cost of a DC welding system suitable for the application.

A typical CD power supply is configured to store energy in a device (e.g. batteries, capacitors, etc.) that can quickly discharge the stored electrical energy. One of the most common methods in the industry is to use a capacitive energy bank, where the electrical energy is converted then stored in capacitors to be used in a future weld process. As such, and for the sake of ease of expression, this document will hereinafter use “capacitors,” “capacitive,” “capacitance,” and other related terms to refer to any energy storage method used in welding applications, including, but not limited to, chemical storage (e.g. batteries), electrical field storage (e.g. capacitors), and/or magnetic field storage (e.g. inductors).

The benefits of the energy storage method are that capacitors have the capability to discharge very high peak current outputs and also have an intrinsic decay rate that functions as a controlled cool-down for the weld spot. However, both of these benefits can become limitations in different applications. Because the system uses a stored energy method, the weld time is limited by the amount of stored energy available. Also, because the slope or decay rate is an intrinsic physical characteristic of the devices used to create the storage device, it is a static parameter that cannot be readily adjusted or controlled.

A typical DC power supply will use a relatively high-powered converter or inverter to generate energy as needed before the weld process. The most common method in the industry is to use an alternating current (“AC”) to direct current (“DC”) converter, which is then stored in a capacitor or capacitors. During the weld, this stored energy is switched onto the weld terminals at some frequency and filtered by a smaller filter capacitor or capacitors to achieve the desired output waveforms. The duty cycle of the switched energy and the filtering determine the shape of the weld waveform. For the sake of ease in expression, this document with hereinafter use “direct current,” “DC,” “converter,” “inverter,” and other related terms to refer to any method used in welding applications that converts an electrical input to an electrical output, including, but not limited to, AC/DC converters (e.g. DC welders, high frequency (“HF”) welders) and AC/AC converters (e.g. AC welders).

The benefits of the DC power supply approach is that longer (e.g., more continuous) welds are possible, and since the output of the DC power supply can be regulated (e.g. by using a high frequency switching mode) to a desired point at any given time which allows the upslope and downslope of the output waveform to be more tightly controlled. The main drawback to the DC power supply is that it can be quite difficult to generate high peak output currents since the energy is generated and supplied from the DC power supply in real time during the welding and is not easily stored.

Accordingly, generating high peak currents from a DC power supply will typically require extensive circuitry within the power supply, and will also require specialized electrical wiring from the building or facility that houses the welder (e.g. high current lines set up to use 3-phase high voltage AC on the main lines). By extension, the development and manufacture of a high current DC power supply that can achieve similar peak weld currents to the traditional CD welder is very costly. The higher power characteristics of this type of power supply will also increase the likelihood of power supply failure.

In contrast, the power supply used in a CD welder is relatively simple with very few components that can fail. Additionally, CD welder power supplies can also can achieve very high peak weld currents for short amounts of time but the weld current decay rate is a function of system capacitance and weld system resistance, which may be limiting. Given this backdrop, most welding applications will dictate the selection of a welding system with either a CD power supply or a DC power supply and various tradeoffs will be made no matter which power supply system is selected. Accordingly, without additional improvements in the power supplies used in welding systems, power supply performance will continue to be sub-optimal.

### BRIEF SUMMARY OF THE INVENTION

A linear DC welder for enhanced welding capabilities comprises one or more active filtering circuits. The active filtering circuit(s) are capable of producing a variety of user-configurable and user-controllable custom waveforms for use in various welding applications. The custom waveforms may be created and combined via the use of overlay waveforms and, in at least some preferred embodiments of the present invention, include agitation waveforms. The overall operation of the welder, including the power supply and the active filtering circuit(s) can be controlled via an integrated feedback cycle that provides for the monitoring and adjustment of multiple weld process parameters including volts, amps, power, resistance, and displacement. Additionally, a low current ignition (“LCI”) circuit may also be included to provide for additional welding options. In at least some preferred embodiments of the present invention, the entire welding operation may be controlled and adjusted by interacting with a graphical user interface.

The welding system power supply for the most preferred embodiments of the active linear DC welder disclosed herein may combine a standard power supply or isolated power sources that combine both capacitive discharge and direct current types into a single unit. The power supply of the present invention allows a welding system to deliver both capacitive discharge power delivery models (characterized by high peak currents and short pulse durations) and controlled direct current power delivery models (characterized by limited peak current and sustained energy output for a longer duration). Multiple power sources may be combined in various parallel and sequential configurations, based on the specific needs of the welding application. Further, the specific configurations of the active filter circuits may be determined by the welding application.

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a circuit for use in conjunction with a power supply used in conjunction with a prior art linear DC welder;

FIG. 2 is a schematic diagram of a circuit used in conjunction with a power supply for an active filter linear DC welder in accordance with a preferred embodiment of the present invention;

FIG. 3 is a schematic diagram of a pair of waveforms comparing an active filter waveform to a passive filter waveform;

FIG. 4 is a schematic diagram of a pair of waveforms comparing the waveform produced by an active filter to the waveform produced by a passive filter;

FIG. 5 is a schematic diagram of a low current ignition (“LCI”) circuit used in conjunction with a power supply for an active linear DC welder in accordance with a preferred embodiment of the present invention;

FIG. 6 is a schematic diagram of a waveform associated with an LCI circuit in accordance with a preferred embodiment of the present invention;

FIG. 7 is a schematic diagram of a waveform associated with an active filter LDC welder in accordance with a preferred embodiment of the present invention;

FIG. 7A is a schematic diagram of a waveform associated with an active filter LDC welder in accordance with a preferred embodiment of the present invention;

FIG. 7B is a schematic diagram of a waveform associated with an active filter LDC welder in accordance with a preferred embodiment of the present invention;

FIG. 7C is a schematic diagram of a waveform associated with an active filter LDC welder in accordance with a preferred embodiment of the present invention;

FIG. 7D is a schematic diagram of a waveform associated with an active filter LDC welder in accordance with a preferred embodiment of the present invention;

FIG. 7E is a schematic diagram of a waveform associated with an active filter LDC welder in accordance with a preferred embodiment of the present invention;

FIG. 7F is a schematic diagram of a waveform associated with an active filter LDC welder in accordance with a preferred embodiment of the present invention;

FIG. 7G is a schematic diagram of a waveform associated with an active filter LDC welder in accordance with a preferred embodiment of the present invention; and

FIG. 8 is a schematic diagram of an alternate preferred embodiment of an active filter circuit with diode isolation used in conjunction with a power supply for an active filter linear DC welder in accordance with a preferred embodiment of the present invention.

It should be noted that the timing, energy, voltage, and the corresponding effects, demonstrated in the figures are not necessarily to scale and are not intended to correlate with exact or quantitative results. They are meant to illustrate the qualitative effects of the invention on the production of waveforms and variations in the waveforms may be exaggerated to highlight the salient characteristics and results associated with the various preferred embodiments of the present invention.

### DETAILED DESCRIPTION OF THE INVENTION

A linear DC welder for enhanced welding capabilities comprises one or more active filtering circuits. The active filtering circuit(s) are capable of producing a variety of user-configurable and user-controllable custom waveforms for use in various welding applications. The custom waveforms may be created and combined via the use of overlay waveforms and, in at least some preferred embodiments of the present invention, include agitation waveforms. The overall operation of the welder, including the power supply and the active filtering circuit can be controlled via an integrated feedback cycle that provides for the monitoring and adjustment of multiple weld process parameters including volts, amps, power, resistance, and displacement. Additionally, a low current ignition (“LCI”) circuit may also be included to provide for additional welding options.

The most preferred embodiments of the present invention are configured to deliver both capacitive discharge energy and controlled direct current energy in various parallel and sequential configurations based on the specific welding application.

In the most preferred embodiments of the present invention, one or more of the filter capacitors associated with the power supply output may be selectively switched on or off during the welding process to produce a filtered weld output that is generally correlated to the pulse width modulation (“PWM”) duty cycle and frequency of the welding capacitor and associated switch(es).

Additionally, the use of a pre-charged filter capacitor bank in the most preferred embodiments of the present invention may reduce the current ramp time to produce a “punchier” weld by making the rise time shorter than a typical passive filter capacitor associated with previously known linear DC welding circuits. Keeping the filter switched off until the desired voltage is reached and/or pre-charging the filter capacitor(s) will generally prevent the weld current from being siphoned off by the filter capacitor. Additionally, actively controlling the filter capacitor helps to prevent the reduction of peak current while generally facilitating the fastest waveform rise time possible. Further, having the filter capacitor charged to the desired set-point voltage also allows a relatively seamless transition to a filtered weld waveform for welding applications where filtering is desired.

In the most preferred embodiments of the present invention, the Q_{FILTER} is turned off at the same time the Q_{WELD} power supply is turned off, thereby stopping the plasma weld or resistance weld directly instead of waiting for the filter capacitors to discharge through completion of the weld plasma or resistance weld cycle. This means the welding process can be stopped more precisely and quickly and the resultant weld does not exhibit the characteristic exponential decay seen with typical LDC welders.

In the most preferred embodiments of the present invention, the Q_{FILTER} may also be left on to produce a smoothing effect for the post weld cycle due to the filter cap discharge characteristics and will typically contribute to weld puddle smoothing in a plasma discharge welding system.

Q_{FILTER} power supply, coupled with C_{FILTER} capacitor, can be used as an independent weld bank if the Q_{WELD} power supply is turned off and the C_{WELD} capacitor has been charged to a voltage equal to or greater than the filter capacitor voltage. In the most preferred embodiments of the present invention, the weld capacitor will most preferably be charged to the same level as the weld bank filter.

The weld capacitor, C_{WELD}, can be used as an agitative overlay to welds produced by the filter capacitor, C_{FILTER}, as long as the weld capacitor C_{WELD} Volts >=C_{FILTER} Volts.

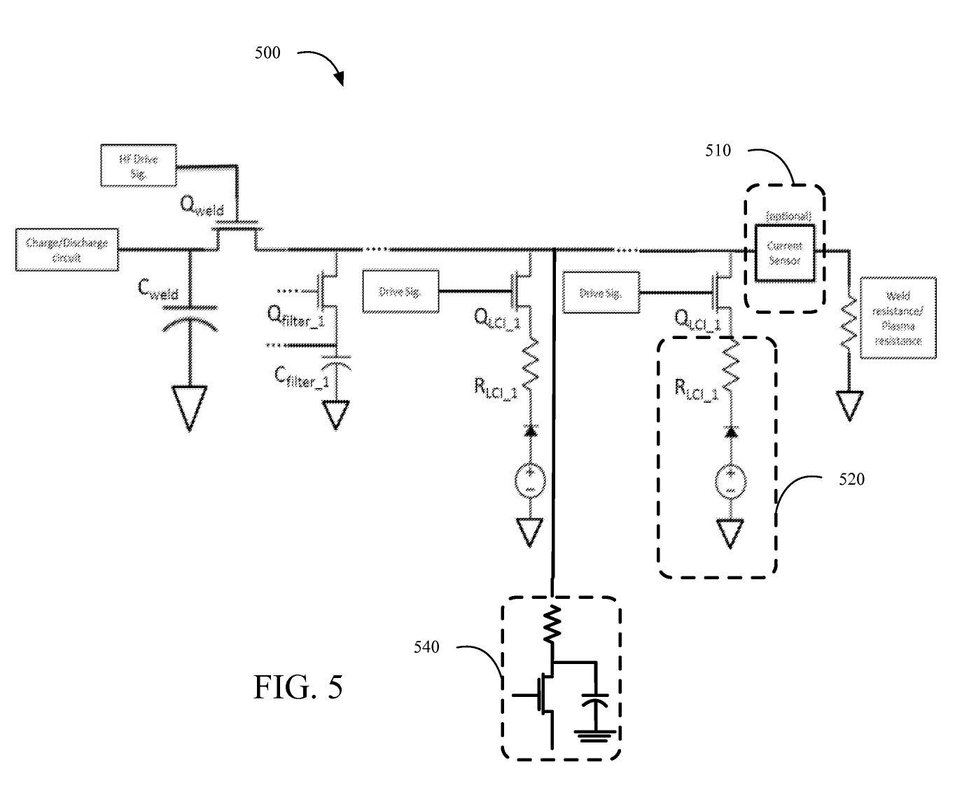

With the addition of a current monitoring and/or voltage monitoring circuit such as circuit 510 of FIG. 5, the weld computer can control the Q_{WELD} or Q_{NANO} MOSFETs (or other transistors) in conjunction with a filter capacitor at high frequency PWM to produce a desired current or voltage weld waveform. Real time or close to real time feedback from the current or voltage monitors can then be used to adjust the PWM of the transistors to correct variations from the desired waveform.

Additionally, the most preferred embodiments of the present invention are configured to detect electrode liftoff when using a low current ignition (“LCI”) circuit and to perform monitoring of weld parameters. Additional information about the LCI circuit is presented below. It should be noted that the LCI circuit is used to help start a smaller (e.g., lower current) pilot arc when the active filter LDC is used for applications such as pulse arc/micro TIG welding. The pilot arc allows the electrode tip to lift of the surface of the part, producing a small low current arc, without starting the melting process. The welder then can detect lift-off, via voltage and current feedback, and then send the main weld energy/waveform to produce the weld.

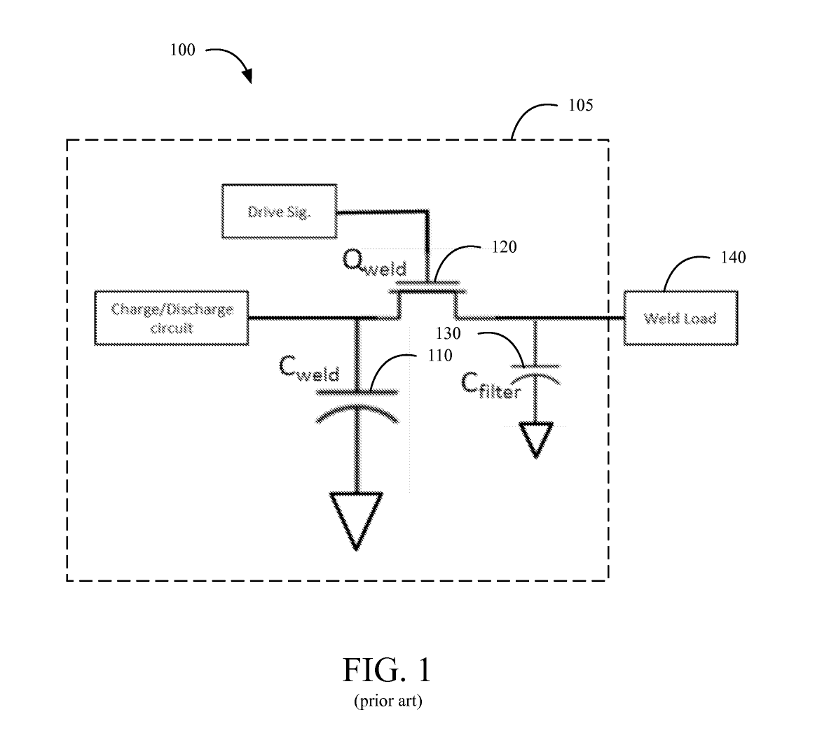

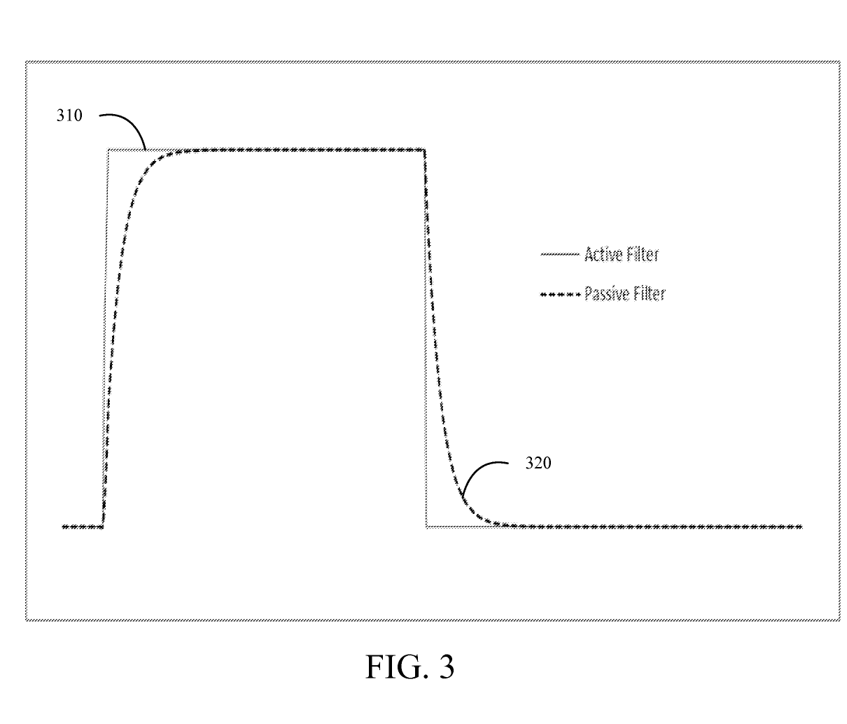

Referring now to FIG. 1, a prior art linear DC welding power supply 105 is depicted. As is known to those skilled in the art, a pulse width modulation cycle with one or more weld capacitor(s) 110 is used to switch and filter the output of a power supply 120, using a passive filter capacitor 130 to supply weld energy to weld load 140. The output of power supply 105 is filtered using one or more passive capacitive filters 130 to allow generation of a desired waveform by actively changing the duty cycle of the weld switches. When the weld array is turned on, filter capacitor 130 is charged. As the weld array is turned off, filter capacitor 130 discharges, producing weld current. The waveform produced by power supply 105 is characterized by the rise and fall of the energy as depicted in FIG. 3 below.

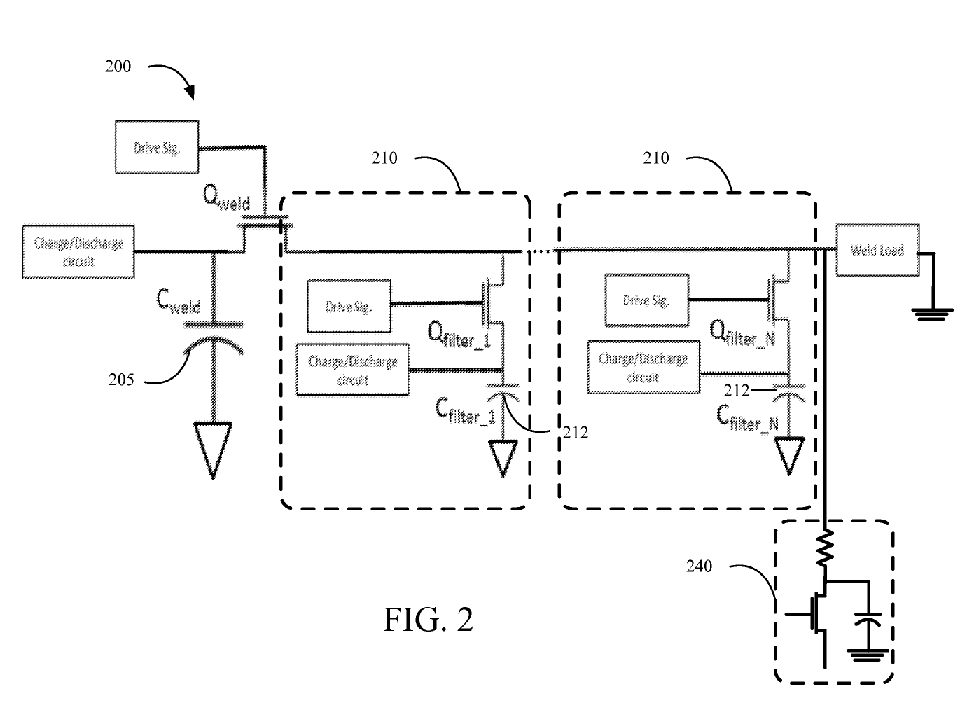

Referring now to FIG. 2, a schematic circuit diagram of a power supply 200 using one or more active filtering circuits in accordance with a preferred embodiment of the present invention is depicted. As shown in FIG. 2, power supply 200 comprises a “main” weld bank or banks of power supply capacitors 205 followed by one or more user selectable and user configurable active filter circuits 210, with each active filter circuit 210 comprising one or more filter capacitors 212. It is important to note that in at least one preferred embodiment of the present invention, capacitors 205 may be super capacitors, ultra capacitors, graphine capacitors, or other capacitors known to those skilled in the art or later develop enhancements of the same.

Filter capacitors 212 of active filter circuits 210 can be pre-charged to any of a number of pre-determined energy levels, and switched on or off during the weld cycle, to allow the user to create specific waveforms with characteristics suitable for a variety of welding applications or, alternatively, can be switched on and off during the welding process to produce additional welding waveforms that are not capable of being produced by a passive filter circuit associated with prior art linear DC welder power supplies.

In the most preferred embodiments of the present invention, weld bank capacitors 205 are driven at high frequency and, as shown in FIG. 2, the present invention linear DC filter circuit allows a plurality of filter capacitors to be switched in and out of circuit by use of a transistor such as a metal-oxide-semiconductor field-effect transistor (MOSFET, MOS-FET, MOS FET, etc.) or some similar type of transistor or circuit component typically used for amplifying or switching electronic signals known to those skilled in the art for switching circuit elements. With this specific approach, the rate of decay for the slope is generally not considered to be an issue when a capacitor is switched out of the circuit because it no longer impacts the resulting output weld wave form.

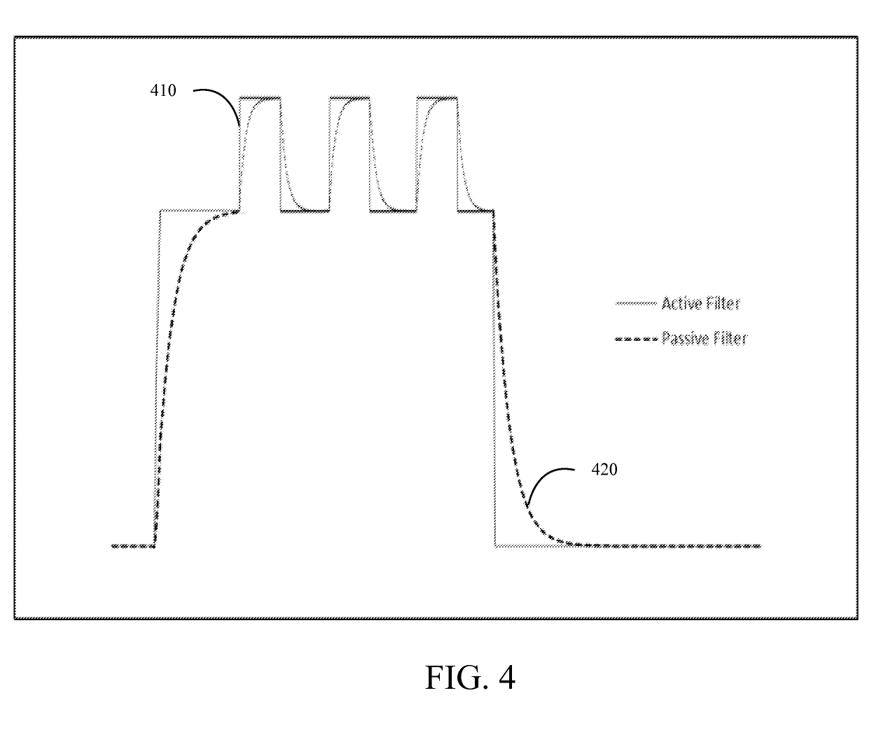

Filter capacitors 212 may also be pre-charged or discharged and used as a weld bank like the main welding bank (without the main weld bank of capacitors). Fast weld current rise time is most beneficial for welding applications where highly conductive materials such as copper are to be welded. In addition, because filter capacitors 212 can be switched on or off during the weld cycle, faster transitions of (for example) weld agitation can be produced actively during a weld by turning off the filter (see FIG. 4 below). The on/off timing sequence can be coordinated with the weld PWM such that a more square-wave type of overlay or subtraction is produced without the capacitive roll-off characteristic of prior art passive filter capacitors.

This same feature can be useful at the end of the weld cycle and, by switching filter capacitor 212 out of the weld circuit, a square-wave like downward end transition can be created in the waveform. This is described in conjunction with FIG. 3 below. In addition, with weld capacitors 205 switched off, filter capacitors 212 may be used as a welding bank to create a capacitive discharge waveform with no filtering. Alternatively, if one active filter circuit 210 is used to filter the waveform, the waveform can also be filtered but with finer energy refinement because more filters may be used in certain applications and less filters may be used in other applications. Each variation or combination provides for more granular control of the resulting waveform. The various preferred embodiments of circuit 200 can be used for production of resistance welding waveforms, plasma discharge waveforms, or traditional power supply waveforms etc.

In the most preferred embodiments of the present invention, Q_{FILTER} of a filter circuit 210 is turned off at the same time the Q_{WELD} power supply is turned off, thereby stopping the plasma weld or resistance weld directly instead of waiting for the filter capacitors to discharge through completion of the weld plasma or resistance weld cycle. This means the welding process can be stopped more precisely and quickly and the resultant weld does not exhibit the characteristic exponential decay seen with typical LDC welders.

In the most preferred embodiments of the present invention, the Q_{FILTER} may also be left on to produce a smoothing effect for the post weld cycle due to the filter cap discharge characteristics and will typically contribute to weld puddle smoothing in a plasma discharge welding system.

Q_{FILTER} power supply, coupled with C_{FILTER} capacitor, can be used as an independent weld bank if the Q_{WELD} power supply is turned off and the C_{WELD} capacitor has been charged to a voltage equal to or greater than the filter capacitor voltage. In the most preferred embodiments of the present invention, the weld capacitor will most preferably be charged to the same level as the weld bank filter.

Weld capacitor 205 can be used to generate an agitative overlay to welds produced by the filter capacitor, C_{FILTER}, as long as the voltage at weld capacitor C_{WELD} Volts >=the voltage at C_{FILTER}. Circuit 240 represents an LCI circuit suitable for use in conjunction with at least one alternate preferred embodiment of the present invention. As shown in circuit 240, Q_{LCI} is coupled to a filter capacitor C_{LCI} filter and a current limited resistor R_{LCI}. Q_{LCI} is PWM and filtered to the desired LCI amperage to provide for more robust weld ignition and plasma sustaining The most preferred embodiment of the LCI circuit is circuit 520, shown below in FIG. 5. Q_{LCI} is turned on and off to provide a R_{LCI} current limited pilot arc. The power supply of the LCI circuit is diode isolated to prevent higher weld voltages onto the power supply. FIG. 5 also illustrates how multiple LCI circuits can be combined to allow variable LCI pilot arc current during a welding process.

Additionally, in at least one preferred embodiment of the present invention a computer-based welding control system with a graphical user interface may be used to select and generate various output waveforms. Similarly, with the addition of a current monitoring and/or voltage monitoring circuit to the circuit shown in FIG. 2, the computer-based welding control system can be programmed to automatically control the Q_{WELD} or Q_{FILTER} MOSFETs (or other transistors) in conjunction with a filter capacitor at a high frequency PWM to produce a desired current or voltage weld waveform. Real time or close to real time feedback from the current or voltage monitors can then be used to adjust the PWM of the transistors to correct variations from the desired waveform.

Additionally, the most preferred embodiments of the present invention are configured to detect electrode liftoff and monitoring of weld parameters, etc. using a low current ignition (“LCI”) circuit. Additional information about the LCI circuit is presented in conjunction with the description of the figures below.

Referring now to FIG. 2 and FIG. 3, a welder power supply output waveform 310 and a welder power supply output waveform 320 are depicted. As shown in FIG. 3, waveform 310 is produced by a linear DC welder power supply using an active filter circuit (as in FIG. 2) in accordance with a preferred embodiment of the present invention. Waveform 320 is produced by a linear DC welder power supply using a standard passive filter circuit, similar to those produced by a prior art linear DC welder power supply. The pre-charging feature when an active filter circuit 210 is being used as a filter capacitor creates a much faster rise time for the welding voltage to produce a fast current rise of the weld waveform, providing the squared off corners of waveform 310.

Referring now to FIG. 2 and FIG. 4, a pair of agitative overlay waveforms is depicted. As shown in FIG. 4, welding waveforms with “agitation” can be added or subtracted from the output generated by the welder's power supply, with both passive filtering systems and active filtering systems. In at least one preferred embodiment of the present invention, by turning active filter circuits 210 and the associated filter capacitors 212 on and off, sharp transitions in agitative overlay/subtraction waveform 410 can be produced. A standard passive LDC “agitation” waveform 420 is shown for comparison purposes and the delays in rise time as well as the slope decay can be seen.

Referring now to FIG. 5, a schematic diagram of a low current ignition (“LCI”) circuit 500 used in conjunction with a power supply for an active linear DC welder in accordance with a preferred embodiment of the present invention is depicted. As shown in FIG. 5, an LCI circuit can be used to produce a pilot arc for aid in weld generation. The use of a pilot arc in conjunction with voltage or current sensing circuit (or no sensing) allows an arc to be established even if retraction of the weld electrode is different than anticipated. Weld current sensor 510 shows one possible location where the weld current can be measured. Those skilled in the art will recognize that the weld voltage can also be measured at this location. These current and voltage values can be used to allow computer controlled waveform shaping and adjustment during the welding process so as to achieve the desired results.

Additionally, a pilot arc with voltage or current sensing 510 will also allow a computer that is configured to control the welding process to know when a pilot arc has been established. Once the pilot arc has been established, the computer can initiate the main weld waveform. This produces a repeatable weld pattern because resistance weld energy is not lost when the welding electrode is in contact with the work piece.

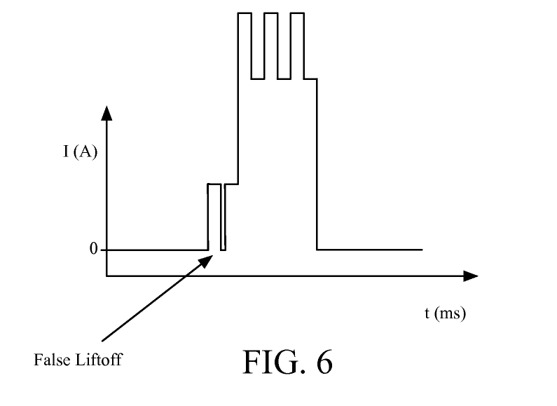

Referring now to FIG. 6, a schematic diagram of a waveform associated with an LCI circuit in accordance with a preferred embodiment of the present invention is depicted. As shown in FIG. 6, the delay to initiate the welding pulse should be selected to eliminate false liftoffs (shown in the waveform of FIG. 6). Care should be taken in delay timing to insure that the weld electrode is close enough to the work piece to accomplish the desired weld penetration. In addition, the pilot arc can also be used as a background arc with multiple bursts of main or secondary welding arcs being overlapped. The background arc prevents the plasma from extinguishing between main weld bursts but may not contribute materially to the actual welding results.

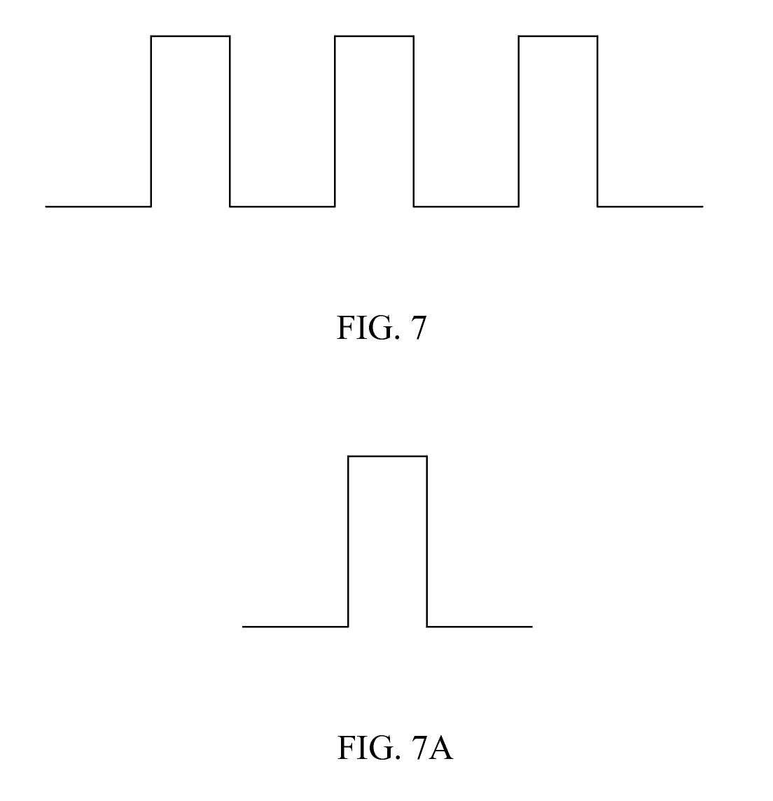

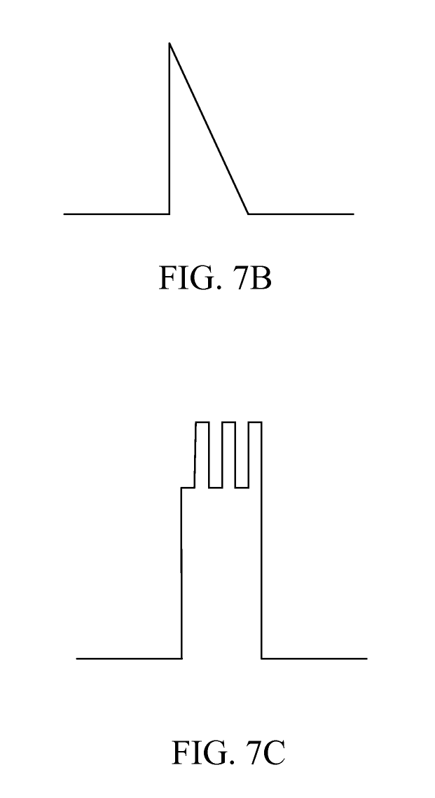

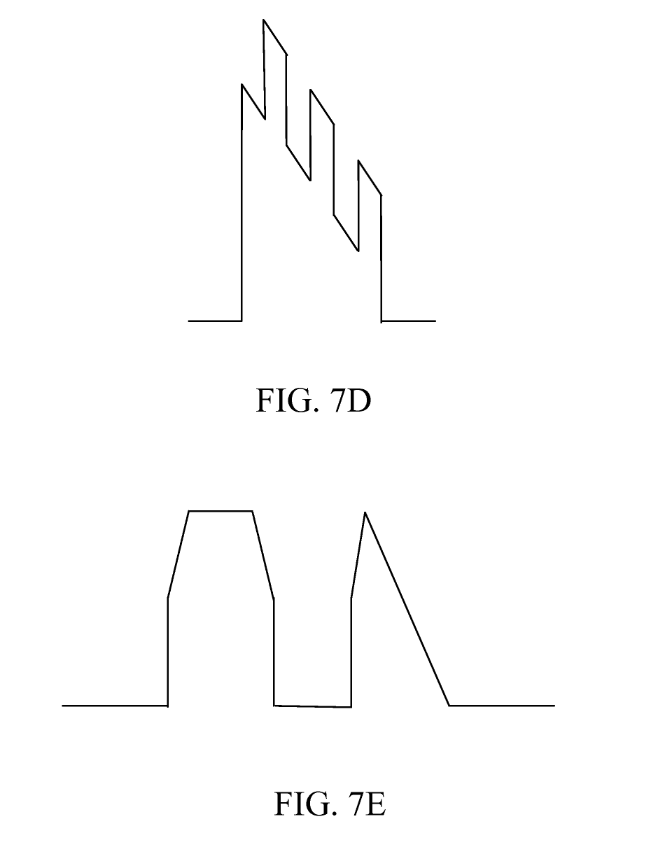

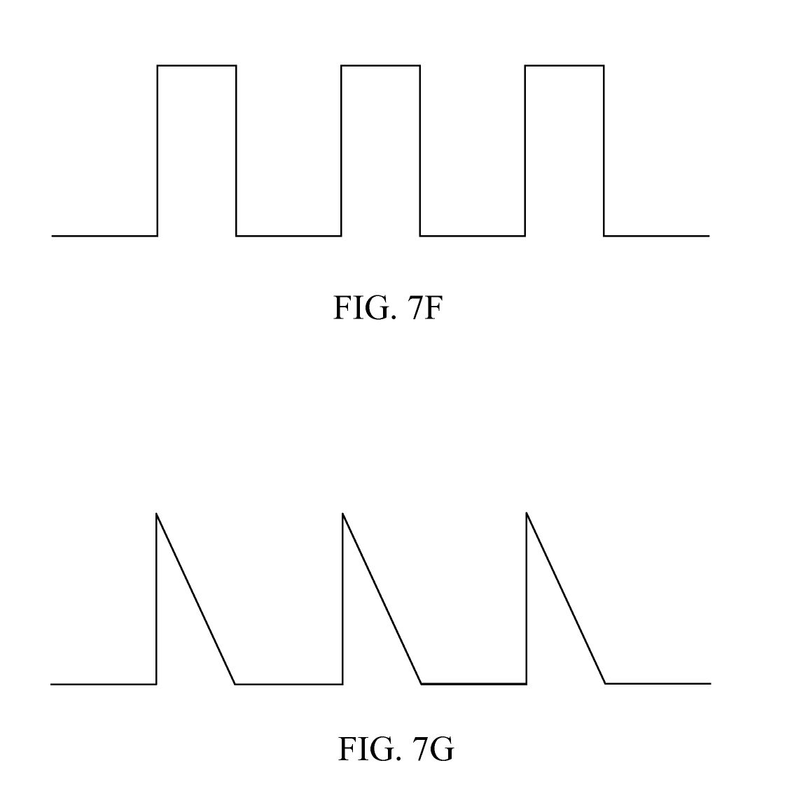

Referring now to FIG. 7-FIG. 7G, a series of schematic diagrams of various waveforms associated with an active filter circuit in accordance with a preferred embodiment of the present invention are depicted. These figures are intended to illustrate a sample of the types of waveforms that may be generated by circuit 200 of FIG. 2. Those skilled in the art will recognize that any waveform within the energy and voltage envelope of the capacitor used in the circuit can be produced. As previously mentioned, the use of ultra-capacitors and other forms of capacitors are an option to increase the waveform options.

Some typical pre-set waveforms may include square waves (FIG. 7 and FIG. 7A, a classic pulse arc emulator including a cap discharge or agitative triangle (FIG. 7B), an agitative square (FIG. 7C), an agitative pulse arc emulator (FIG. 7D), a ramped (e.g., modified square or pulse arc emulator) (FIG. 7E), a pulsation square (FIG. 7F); and a pulsation pulse arc emulator with or without agitation, ramps, etc. (FIG. 7G). For the ramped or modified square wave, it should be noted that an arc is most preferably established prior to the ramp section of the wave.

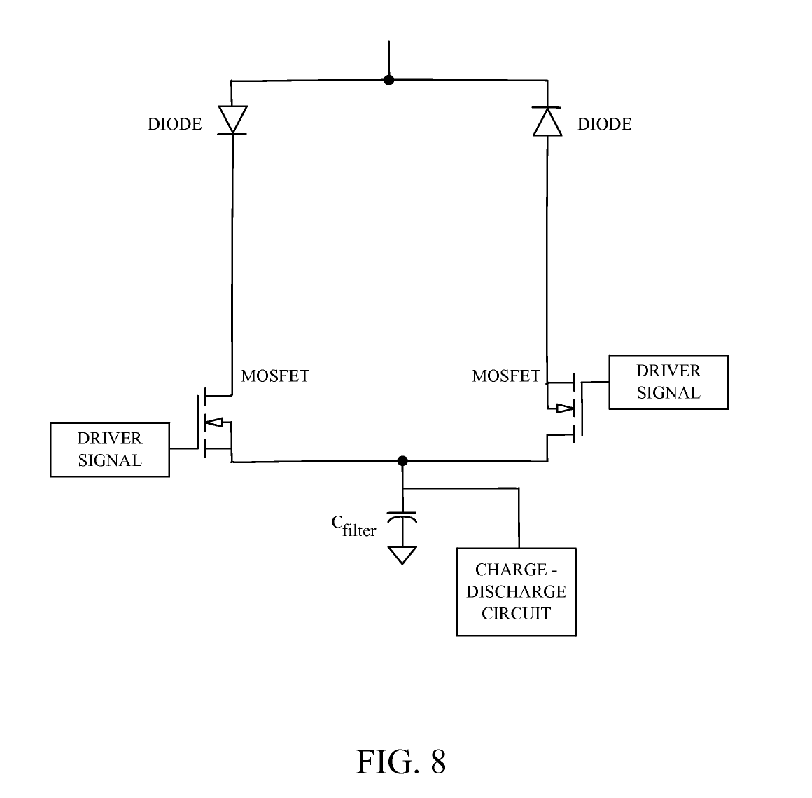

Referring now to FIG. 8, active filter circuit 800 in accordance with an alternative preferred exemplary embodiment is depicted. Circuit 800 allows a sharper transition to on/off over the preferred embodiment over active filter circuit 210 shown in FIG. 2. The MOSFETs are positioned in opposing directions with corresponding diodes in opposing directions. When the MOSFETs are not on, the voltage from the weld circuit is blocked by the MOSFETs itself on one side of the circuit path and the diode on the other side of the circuit path. This provides a circuit where the active filter does not need to be charged to a higher voltage than the weld path to prevent backflow of current into the filter capacitor. Circuit 800 may be used in place of circuit 210 for welding applications where sharper transitions are desired and/or necessary.

With two of these filter circuits in place, with one in a higher state and the other in a lower state, the active filter circuit can be used in conjunction with the weld field effect transistor operated at a higher PWM duty and a lower PWM duty to produce a frequency agitation waveform that is both sharper and higher than the active filter circuit embodiment of FIG. 2 or a classic LDC waveform. In addition, larger filter caps may be used to produce smoother welding waveforms (e.g., with less ripple) without the detrimental effects of the larger filter on the transitions (high to low, transitions, etc.) of the weld waveforms.

Those skilled in the art will recognize that the active filter circuits described herein can be operated in conjunction with one or more methods to selectively energize or de-energize the active filter circuits to enhance the variety of welding wave forms produced by a welder utilizing one or more of the preferred embodiments of the power supply circuits described herein. The methods will generally involve the switching on or off of one or more of the active filter circuits, the pre-charging or discharging of one or more of the active filter circuits, all to control the output wave form of the welder.

It is important to note that the active filters disclosed herein are suitable for use in a variety of welding applications, using technologies such as those disclosed in U.S. patent application Ser. No. 14/262,743. In that application, a power supply assembly for a capacitive discharge welder comprises an integrated thermal management system. The housing of the power supply assembly allows the integration of ultra-capacitor thermal management with electrical connectivity and mechanical modularity. In the most preferred embodiments of the present invention, aluminum (or other conductive material, such as copper, etc.) channels are shaped and arranged to both act as thermal fin elements for the removal of waste heat and as an electrical path (parallel, series or a combination of series and parallel) with a relatively low electrical resistance. The fin elements are attached to the capacitor terminals of the power supply housing using nuts and bolts, welds, or other acceptable methods known to those skilled in the art.

The thermal fin assembly can be designed to comprise naturally self-isolating elements. Additionally, the thermal fin components may also be electrically isolated from each other by the use of an electrically insulating material (e.g. plastic) to create an insulative outer layer or shell around the thermal fin assembly. The insulative outer shell and the metal fins also cooperate to form a wind tunnel and allows a single ultra-capacitor power supply module to be stacked and/or mounted in series or parallel with plurality of similar ultra-capacitor power supply modules to create a larger power supply. Airflow within the housing may be directed via fan or other method into the ultra-capacitor wind tunnel to remove heat from the capacitor cylinder itself as well as the thermal conductive fin elements. Two fin elements allow attachment of an external electrical path for the charging and discharging of the capacitor array.

In addition, the active filter circuits and components disclosed herein may be suitably used in conjunction with a welding system power supply such as the power supply disclosed in U.S. patent application Ser. No. 13/674,022. The power supply combines isolated power sources of both capacitive discharge and direct current types into a single unit. The disclosed power supply allows a welding system to deliver both capacitive discharge power delivery models (characterized by high peak currents and short pulse durations) and controlled direct current power delivery models (characterized by limited peak current and sustained energy output for a longer duration). Multiple power sources for the power supply are combinable in various parallel and sequential configurations, based on the specific needs of the welding application.

Similarly, the active filters disclosed herein are suitable for use in conjunction with a capacitive discharge welder that comprises a series of super capacitors (or ultra-capacitors) used as a power source such as those disclosed in U.S. patent application Ser. No. 14/084,575. The capacitive discharge welder disclosed therein also comprises a dual function circuit that serves as an emergency stop circuit that is capable of redirecting or disconnecting the weld path in certain applications and situations and a drain circuit to drain a filter capacitor. The capacitive discharge welder disclosed therein is also configured to use the super capacitor power supply in a direct discharge configuration as a CD welder. Additionally, the super capacitors may be switched at frequency through a filter capacitor to produce a shaped DC welding waveform suitable for a wide variety of welding applications.

From the foregoing description, it should be appreciated that a linear DC welder with a power supply including active filter circuits presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A circuit for a power supply comprising:
a plurality of power supply capacitors;
a drive signal;
a charge/discharge circuit coupled to the plurality of power supply capacitors; and
at least one active filter circuit coupled to the circuit, the at least one active filter circuit being selectively switched on or off to create a plurality of welding wave forms.

2. The circuit for the power supply of claim 1 wherein the at least one active filter circuit comprises:
a filter transistor;
a filter capacitor coupled to the transistor;
a drive signal coupled to the filter transistor; and
a charge/discharge circuit coupled to the filter transistor.

3. The circuit for the power supply of claim 1 wherein the at least one active filter circuit is pre-charged to a pre-determined energy level.

4. The circuit for the power supply of claim 1 further comprising a weld load coupled to the power supply.

5. The circuit for the power supply of claim 1 further comprising a low current ignition circuit coupled to the power supply circuit.

6. The circuit for the power supply of claim 1 wherein the plurality of power supply capacitors are driven at a high frequency.

7. The circuit for the power supply of claim 1 wherein the at least one active filter circuit is cycled off and on to produce an agitative overly.

8. The circuit for the power supply of claim 1 wherein the at least one active filter circuit is cycled off and on and coordinated with a pulse width modulation to create a square wave form with reduced capacitive roll-off.

9. The circuit for the power supply of claim 1 wherein the at least one active filter circuit comprises a plurality of active filter circuits wherein each of the active filter circuits comprises:
a filter transistor;
a filter capacitor coupled to the transistor;
a drive signal coupled to the filter transistor; and
a charge/discharge circuit coupled to the filter transistor.

10. The circuit for the power supply of claim 1 wherein the plurality of power supply capacitors comprise a plurality of super capacitors.

11. The circuit for the power supply of claim 1 wherein the active filter circuit comprises:
a pair of transistors positioned in opposing directions; and
a pair of diodes, with one of the pair of diodes being coupled to each of the pair of transistors so that when the pair of transistors are switched off, a voltage applied to the circuit for the power supply is blocked by at least one of the pair of transistors and at least one of the pair of diodes.

12. A power supply circuit for a linear direct current welder comprising:
a plurality of power supply capacitors;
a drive signal coupled to the power supply capacitors;
a charge/discharge circuit coupled to the plurality of power supply capacitors;
a plurality of active filters circuit coupled to the power supply circuit, the plurality of active filter circuits being selectively switched on or off to create a plurality of welding wave forms, wherein each of the plurality of active filter circuits comprises:
a filter transistor;
a filter capacitor coupled to the transistor;
a drive signal coupled to the filter transistor; and
a charge/discharge circuit coupled to the filter transistor;
a low current ignition circuit coupled to the power supply circuit; and
a welding load coupled to the power supply circuit.

13. The circuit for the power supply of claim 12 wherein the plurality of filter circuits is cycled off and on and coordinated with a pulse width modulation to create a square wave form with reduced capacitive roll-off.

14. The circuit for the power supply of claim 12 wherein the at least one active filter circuit is pre-charged to a pre-determined energy level.

15. The circuit for the power supply of claim 12 further comprising a low current ignition circuit coupled to the power supply circuit.

16. The circuit for the power supply of claim 12 wherein the plurality of power supply capacitors are driven at a high frequency.

17. The circuit for the power supply of claim 12 wherein the plurality of active filter circuits are cycled off and on to produce an agitative overly.

18. A method of creating a plurality of welding waveforms, the method comprising the steps of:
providing a power supply for use in a linear direct current welder, the power supply comprising:
a plurality of power supply capacitors;
a drive signal;
a charge/discharge circuit coupled to the plurality of power supply capacitors; and
at least one active filter circuit coupled to the circuit, the at least one active filter circuit being selectively switched on or off to create a plurality of welding wave forms; and
selectively activating the at least one active filter circuit in the power supply to create the plurality of welding waveforms.

19. The method of claim 18 wherein the step of selectively activating the at least one active filter circuit in the power supply to create the plurality of welding waveforms comprises the step of creating an agitative overlay by turning the at least one active filter circuit on and off.

20. The method of claim 18 further comprising at least one of the steps of:
pre-charging the at least one active filter circuit to create the plurality of waveforms; and
discharging the at least one active filter circuit to create the plurality of waveforms.
